(19) United States
(12) Patent Application Publication
(10) Pub. No.: US 2010/0139420 A1
(43) Pub. Date: Jun. 10, 2010

(54) CELL FOR CONFINEMENT OF VERY SMALL VOLUMES OF SOFT MATTER AND FLUIDS

(76) Inventors: Gabriel John Simon Ohlsson, Vallda (SE); Christoph Langhammer, Mölndal (SE); Igor Zoric, Göteborg (SE); Bengt Kasemo, Köpmannebro (SE)

Correspondence Address: Gabriel Ohlsson, Grappasvagen 77, Vallda, SE-434 92, SE

(21) Appl. No.: 12/442,962

(22) PCT Filed: Sep. 27, 2007
(86) PCT No.: PCT/SE2007/000859

§ 371 Date: Dec. 17, 2009

Related U.S. Application Data
(60) Provisional application No. 60/827,089, filed on Sep. 27, 2006.

(51) Int. Cl. B01L 3/00; B23P 17/04

(52) U.S. Cl. 73/864.91; 29/428

(57) ABSTRACT

The present invention relates to a nanocell, and method for manufacturing same, for holding small volumes of soft matter confined in a gap of order 1 micrometer or smaller and measurement systems using the same. The nanocell comprise:
a first structure (3) with a substantially flat surface in one direction;
a second structure (6) with a substantially flat surface in one direction; and
at least one spacer (1, 2);
   wherein said substantially flat surface of each first and second structure face each other and are separated by the at least one spacer and the two surfaces and the spacer together define a volume (7) between them for holding said soft matter or fluid, and the distance defined by the spacer between said surfaces of the first and second structure is less than 1 micrometer; the volume between the surfaces of the first and second structures and the spacer is in the range between 1 femto liters and 1 micro liters.

The present invention relates to a cell for confinement of soft matter and fluids and chemical reactants in a very small volume by controlling one dimension (cell height) on the nanometer scale.

### INTRODUCTION

The ability to handle very small volumes of soft matter, liquids and gases, of the order of 1 10 μl and below, or 10⁻³ μl and below, as in examples given herein, is of great scientific and technical interest. By carrying out measurements of chemical and physical properties of confined soft matter and fluids, in a regime where surface induced effects dominate over the bulk, a range of interesting phenomena like wetting effects, changes of phase transition temperatures, interfacial slip, etc. can be addressed experimentally. The fact that the range of a surface potential typically extends at most about 5 nm into the bulk implies that in a film with a thickness of about 100 nm, ca 10% of the volume will be strongly affected by the surface interactions. Thus the ability to address samples with a thickness below 100 nm with an experimental device is highly interesting. A number of possible areas of application for such a device are presented below.

The field of soft matter covers a wide range of materials, which are relevant for a large number of applications. As a first example, liquid crystals are a type of soft matter that is of great industrial interest because of their use in flat screens and displays and in optoelectronic devices. At the vicinity of surfaces the physical properties are different from those in the bulk due to interfacial anchoring and orientational effects. The trend of the industry is to make thinner screens with larger area, thus making interface related effects more important. However, so far it has been difficult to experimentally investigate interface induced effects in confined liquid crystals systems.

A gel is a type of soft matter that comprises a soft structure like a skeleton. In the vicinity of a surface this structure is changed and undergoes a wetting transition. This occurs within a distance from the surface corresponding to a material characteristic value called the spinodal wavelength. If one has a confined volume of a gel and decreases the thickness below this characteristic value the entire gel is going to wet. With the method developed in this work surface wetting of gels with very small spinodal wavelengths may be further investigated. The different surface effects occurring are of great interest when developing gels with a more controlled behavior at the surfaces since deformation of the structure makes it hard to obtain the desired properties in small confined volumes.

Another example of a physical phenomenon in a confined soft matter system is a phase separation in polymer mixtures that takes place when the polymers are held in a confined space smaller than the mentioned spinodal wavelength. This phenomenon can also be described in terms of a characteristic scale of the bulk phase separation pattern or, in other words, the scale of the fluctuations of the initial phase separation. The wavelength of these fluctuations is typically of the order of 100-200 nm for polymers. Since mixes of polymers tend to form layers at interfaces giving undesired properties, this phase separation is of great technical interest in the context of polymer processing.

Yet another field of interest is a reactor cell that is able to confine volumes of soft matter and can be used to simulate chemical reactions that take place on a small scale in living creatures and other biological systems. The smaller reaction cell and fluidic devices one can handle the shorter the response time becomes as well as the number of experiments that can be performed simultaneously increases. Bioscientists are interested in studying the properties of cells, DNA and other biological soft materials on this small scale. Already today there exist micro fluidic devices with typical diameters of some hundred micrometers. The possibility to go far below this size scale is therefore very interesting.

Having soft matter confined in a very small volume also opens up for the possibility of performing pure optical analysis. So far, it has been possible to analyze thin free films (without confining surfaces of well defined geometry and interface chemistry) of, for example, polymers. With the invention presented here, uncertainties regarding parameters such as the film thickness, surface structure, molecular orientation, etcetera, can be eliminated. Using transparent or semitransparent bottom and top plates, as well as walls, allows for analysis of the confined sample material by various kinds of optical spectroscopy.

There is also an increasing need for small chemical reactor cells in the micro- or nanoreactor regime in order to e.g. study chemical reactions on nanofabricated model catalysts or for fuel cell applications. The possible solutions to both scientific problems, a nanoreactor cell and a system to study confined soft matter, have in principle to overcome the same problems and provide with a way to manufacture a system with a very large surface to volume ratio. This requires a cell with a surface area in the cm² range and surface-surface distances as small as several nanometers only.

Finally, the whole area of tribology and interfacial slip may possibly be addressed by using a nanocell with extreme confinement in one direction as an experimental device. For example, in a thin film of liquid confined between two solid interfaces, due to the non-slip condition, there will (according to theoretical predictions) be some monolayers of molecules in the very vicinity of the surfaces in which the liquid acts like a solid material. Molecular dynamics simulations of extremely thin confined films (about 5 nm) of n-hexadecane have been performed showing a formation of well-defined molecular layers in the vicinity of the surfaces and stretching into the bulk of the liquid. As the thickness of the confined films is decreased this solid regions should increasingly affect the viscous properties of the film as a whole. The ability to produce few nanometers thick confined films with controlled interfaces thus makes it possible to investigate experimentally phenomena like this, which before only may be performed theoretically.

Based on these possible fields of applications, this document presents an invention of a device that makes it possible to control the thickness of thin films of liquid and soft matter in order to deal with extremely small volumes. The application presented is thought as an extension of the Quartz Crystal Microbalance with Dissipation Monitoring (QCM-D) technique, allowing, among others, to carry out measurements of the viscous properties of soft materials. In this work, the studied systems are the liquid crystal system 5CB (4-n-pentyl-4′cyanobiphenyl) and ethylene glycol, for a thickness range from 500 nm down to 30 nm. These systems were chosen because they very well represent anisotropic and isotropic soft matter systems, respectively. Good control of the orientation of the 5CB molecules is also easily obtained by surface modification. The dissipation and resonant frequency changes for different orientations as a function of temperature were measured using a temperature ramp covering the nematic-isotropic phase transition in the liquid crystal film (typically around 33-35° C.).

Cross-linked polystyrene particles or thermally evaporated thin films of Cr, Ti and Au with the desired geometry respective nano-/micro fabricated PDMS structures were used as spacers in the developed method. These were placed between a QCM-D-crystal and a glass lid, thus forming a sandwich with the liquid in between. Polystyrene particle sizes from less than hundred nanometers up to ten micrometers were used in some experiments. The ability to accurately control the thickness of the studied systems down to the nanometer-range, made it possible to study very thin films of liquid and soft matter under conditions where the bulk no longer determines the properties of the system but where surface induced effects are the dominating contribution.

### SUMMARY

A novel technique is presented for confining soft matter or chemical reactants in a cell, nano-sized in one dimension (very large cell-surface to cell-height ratio), having a volume of the order of 1 μl and less, or 10⁻³ μl and less, as in examples given herein. The nanocell can for example be used for spectroscopic measurements (addressing e.g. static and dynamic properties of soft matter in confined volume), energy dissipation measurements (using e.g. shear waves propagating from a source electrode into the sample) and as a miniature chemical reactor requiring a very small amount of reactants. In the first two application areas the small height of the cell assures the dominant role of the interfaces on the properties of the confined soft matter. The cell very generally can be described as a lid and a bottom plate (both can be optically transparent as well as fabricated from other, non-transparent materials) that are separated by appropriate size spacers. The surfaces of both lid and bottom plate can be modified with appropriate chemistry or a coating, prior to the assembly of the cell, in order to provide with a desired interface(s) for the application.

As an example we present how the novel device is applied to study thin films of the calimatic liquid crystal 5CB (as an example for an anisotropic system) and thin films of the isotropic liquid ethylene glycol. In both cases the cell is used in combination with a device for measurements of energy dissipation through shear waves propagating in oriented or isotropic confined soft matter films. We show that for 5CB, confined within the nanocell with three different and well-defined thicknesses: 30 nm, 280 nm and 600 μm (bulk), with the director (vector along long axis of the 5CB molecules) oriented perpendicular to the shear direction, the changes in resonant frequency and dissipation varies reproducibly with respect to thickness when being probed with a QCM-D sensor. The experiments thus clearly show that surface induced effects become more significant when the sample thickness decreases. In addition it is shown that the resonant frequency and dissipation characteristics vary as a function of molecular direction in the nematic phase and coincide in the isotropic phase for well defined 5CB films confined in a 280 nm thick nanocell. As a second example we present results of energy dissipation measurements for confined ethylene glycol. Thicknesses spanning from 30 nm to bulk (600 μm) were investigated theoretically and experimentally. The lower thickness shows a noticeably higher viscous dissipation than the thicker one, indicating an increase in sensor-lid coupling of the nanocell due to stronger interfacial interactions.

The present invention is realized in a number of aspects in which a first is a nanocell for holding a small volume of soft matter or fluid, said nanocell comprising:

a first structure with a substantially flat surface in one direction;

a second structure with a substantially flat surface in one direction; and

at least one spacer;

wherein said substantially flat surface of each first and second structure face each other and are separated by the at least one spacer and the two surfaces and the spacer together define a volume between them for holding said soft matter or fluid, said surfaces of the first and second structure are substantially parallel to each other, and the distance defined by the spacer between said surfaces of the first and second structure is less than 1 micrometer; the volume between the surfaces of the first and second structures and the spacer is in the range between 1 femto liters and 1 micro liters.

At least one width substantially parallel to at least one of the substantially flat surfaces of the first and second structure may be of the millimeter order.

At least the inner surfaces of the nanocell may have been customized for at least one of optimizing physical and chemical properties depending on measurement. The customization may comprise at least one of geometrical structure, coating, surface structure, and chemical reactivity (e.g. hydrophilic or hydrophobic properties).

The nanocell may further comprise at least one of at least one sensor, at least one membrane, at least one flow inlet, at least one outlet, and at least one flow steering device.

The spacer may be formed integrally of one of the first or second structure. The spacer may comprise a nano sized object. The nano sized object may be at least one of a nanotube, nanowire, and nano sphere. The spacer may be made of at least one of a piezoelectric material and a magnetoelastic material. The spacer may be made of a plurality of layers.

A second aspect of the present invention, a measurement device is provided for measuring physical or chemical properties of soft matter, said device comprising at least one nanocell according to claim 1 with interface connectors for control and measurement electronics, the measurement device further comprising signal processing means and communication interface.

A third aspect of the present invention, a method of manufacturing a nano cell is provided, comprising the steps of:
providing a first structure with a substantially flat surface;
providing at least one spacer structure positioned on the substantially flat surface of the first structure;
providing a second structure with a substantially flat surface on the spacer;
assembling the second structure in relation to the first structure and the at least one spacer;

wherein the spacer structure is less than 1 micrometer in a direction between the surfaces of the first and second structure and the volume defined by the two surfaces and the spacer structure is in the range of 1 femto liters to 1 micro liters.

The step of providing at least one spacer may comprise a step of using at least one of photolithography, electron beam lithography; evaporation techniques, sputtering, masking, colloidal lithography, spin coating, epitaxial growth, and mechanical depositing of particles.

The step of assembling may comprise using at least one of anodic bonding, polymer cross linking, gluing, fusion bonding, magnetic forces, electrostatic forces, and capillary forces.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically an embodiment of the present invention;

FIG. 2 illustrates schematically another embodiment of the present invention;

FIG. 3 illustrates schematically another embodiment of the present invention;

FIG. 4 illustrates schematically another embodiment of the present invention;

FIG. 5 illustrates schematically another embodiment of the present invention;

FIG. 6 illustrates schematically another embodiment of the present invention;

FIG. 7 illustrates schematically another embodiment of the present invention;

FIG. 8 illustrates schematically another embodiment of the present invention;

FIG. 9 illustrates schematically another embodiment of the present invention;

FIG. 10 illustrates schematically another embodiment of the present invention;

FIG. 11 illustrates schematically a use of the embodiment of FIG. 10;

FIG. 12 shows schematically a liquid crystal film confined in a nano cell according to the present invention;

FIG. 13a to b shows example measurements using the present invention;

FIG. 14a to b shows example measurements using the present invention;

FIG. 15a to b shows example measurements using the present invention;

FIG. 16 shows schematically a control device according to the present invention;

### DETAILED DESCRIPTION OF THE INVENTION

The present invention is in one exemplifying embodiment a device (a nanocell) that, in a well controlled way, is able to confine very small volumes, from the micro liter and nano liter regime down to the pico- and femto liter regime (and below), of soft matter, i.e. liquids, polymers, liquid crystals, gels, biological cells and other soft biological matter as well as gases with a very large surface to volume ratio. The intention is to enable measurement and observation of properties and the running of processes at a very small scale, in cases where extremely small film thicknesses and volumes, combined with large surface areas, are desirable. The device may be used in a system with control and measurement electronics, computational devices (such as a PC), physical detectors (e.g. optical detectors, electron detectors, particle detectors, and so on) for measuring different chemical and/or physical characteristics. The device may be connected to different types of mechanical devices, such as a holding structure and/or structures for distributing substances to the device and from the device. Range of volumes in the nanocell range from 1 micro liters down to at least 1 pico liters (or below) with volume examples of 100 nano liters, 10 nano liters, 1 nano liter or 10 pico liters, or 100 pico liters depending on application and type of test to be done.

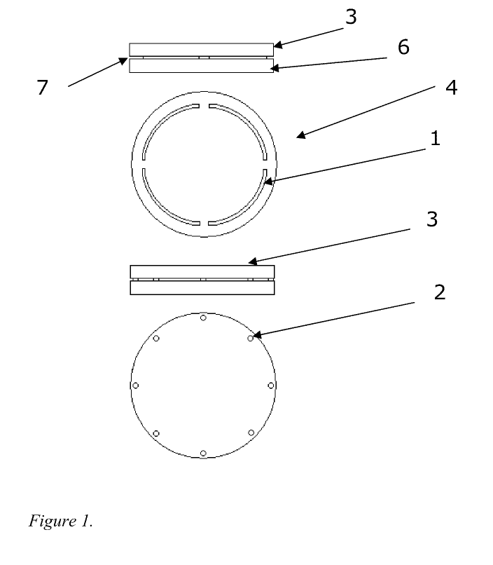

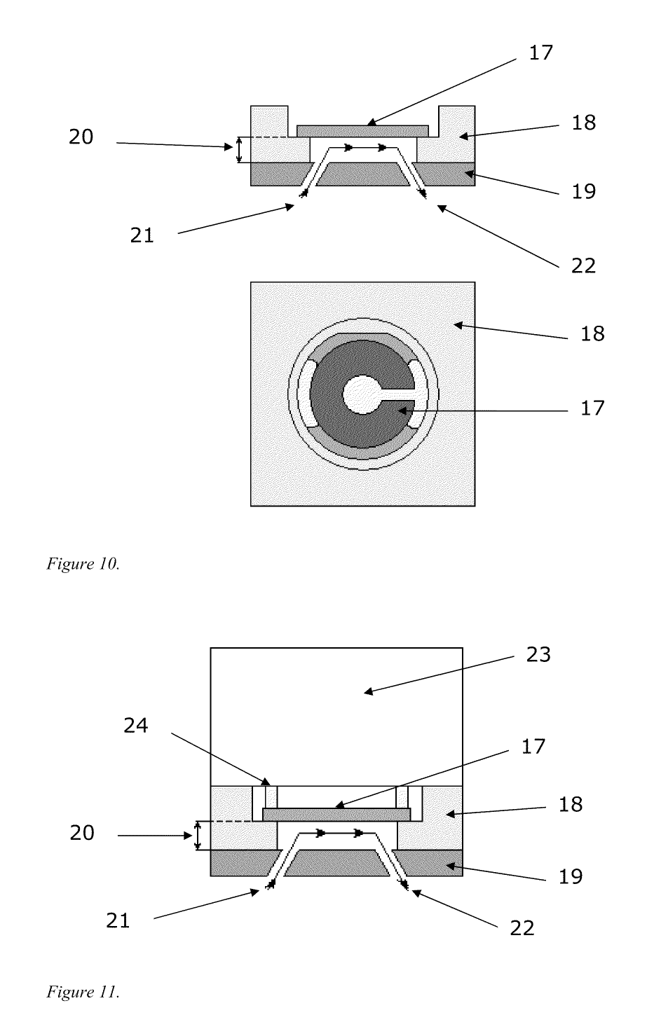

Referring to FIG. 1, the developed device 4 comprises two parallel plates 3 and 6, a bottom 6 and a lid 3, separated by one or several spacers 1 or 2 forming a cell 7 (volume) with a thickness of less than one micrometer down to the nanometer regime, i.e. forming a so called nanocell. The plates might be of varying shape, material and function, depending of the application in specific cases. In order to induce certain properties, such as molecular orientation, binding potential, hydrophilicity or hydrophobicity, etc., at the surfaces, different surface treatments can be performed, e.g. evaporation or sputtering of a metal or a dielectric, spin coating of a thin organic film or other treatments. The spacers are put in place as particles or are fabricated with different techniques, such as photolithography, electron beam lithography or colloidal lithography, or simply masking and evaporation or sputtering of a material, depending on the desired geometry and function of the device. The geometry of the spacers can be of a vast number of different layouts, depending on the function of the cell. It may for example be pillars 2, reducing the influence of the wall area on the confined material or entirely or almost entirely enclosing walls 1, if the evaporation and leakage of the confined matter is to be reduced and perfect control of the radial extension is desired. Further, referring to FIGS. 6, 7 and 8, there may be channels and walls 13 within the cell, forming different reaction chambers 12, 14, for example. Several cells may also be stacked on top of each other. The spacers may be attached to either or both sides of the plates, or alternatively, the cell may be held together by an external or internal force. As an example, the capillary force of an enclosed liquid may hold the plates together, with the latter resting on the spacers providing the desired film thickness. Inlet and outlet structures may be provided for allowing substances to flow to 21 and from 22 the device, referring to FIG. 10. It should be noted that the form of the surface of the lid and/or bottom facing the nanocell may be flat or with a radius (i.e. convex or concave), it may also have other shapes where appropriate (e.g. with a symmetrical or irregular form part of the lid or bottom: e.g. a rectangular or semi spherical indentation in the surface).

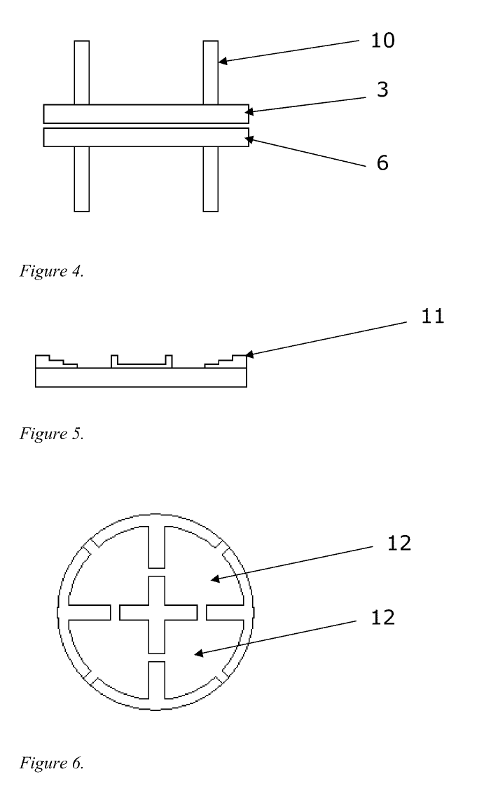

As an alternative, referring to FIG. 4, the plates may be held separated by being attached to external structures 10 and, depending on the application of interest, they may comprise different materials and have different surface treatments or comprise sensors or other probing or read-out devices. Other read-out methods than those mentioned and exemplified in this document may be used in combination with the presented nanocell, such as mechanical, electrical, magnetic, optical, etcetera, depending on which properties and applications that are desired.

When using the cell for optical measurements, the plates may be transparent or semitransparent.

In order to be able to perform membrane catalysis the lid and/or bottom may comprise a selective membrane.

The plates may also comprise electrodes in order to make the nanocell an electro-chemical reactor. They may also have other physical and chemical properties, such as being magnetic, superconducting etc.

Examples of different spacer methods and their typical spacing distance are listed below:

100 nm-1 μm, as in examples given herein: (Cross-linked) colloidal polystyrene spheres (PS) suspended, with an appropriate concentration, and then applied along the edges; photolithography; electron beam lithography; colloidal lithography, more simple masking (e. g. tape) and evaporation techniques.

100 nm and down: Photolithography, electron beam lithography; colloidal lithography and simple masking (e. g. tape) and evaporation techniques.

All cases: Any kind of masking that will define the structure of the cell, and evaporation, sputtering or spin-coating of the spacer materials. The spacers may comprise several layers of different materials, both in the radial as well as in the stacking direction.

As spacers in the nanocell, (carbon) nanotubes/wires and nanospheres may be used as well. Also electromechanical spacers such as piezoelectric or magnetoelastic spacers may be used in order to get a cell with variable height and volume.

The mentioning of the above stated solutions regarding the plates and the spacers, does not exclude the use of plates and spacers with other properties. Other solutions may be used dependent of the desired properties and applications.

The assembling of the cell pieces may be performed in a vast number of ways, including anodic bonding, polymer cross-linking (glueing), fusion bonding, magnetic forces, electrostatic forces, capillary forces etcetera, which may not exclude any other assembling method to be used for the nanocell.

In the case of fabrication of walls for chemical reaction cells the different types of nanolithography are to be preferred.

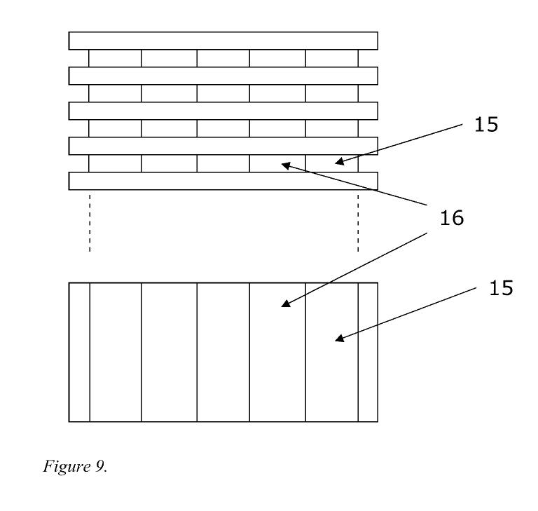

Schematic drawings that show how cells of this kind might look like are shown in FIGS. 1-11 (it should be noted that the Figs are not to scale) and described further below. The nanocell is not confined to have only the geometrical shape of the plates and the spacers, which are presented in FIGS. 1-11 or in this context; these are only to be considered as examples of how it may look like. The shape and layout may depend on what function and application that is desired in each specific case. For example the device might, for some applications, induce confinement in two directions, forming a nano-fluidic channel. A stack of channel devices like in FIG. 9, or similar, may serve as a filter, for gases as well as for soft matter and mixes thereof, for example in emulsion processes.

The terms “lid”, “top” and “bottom” does not mean that the nanocell has to be oriented in a certain direction, but is only used for providing an easy way to describe and interpret the main principle of the invention.

### Example of Application

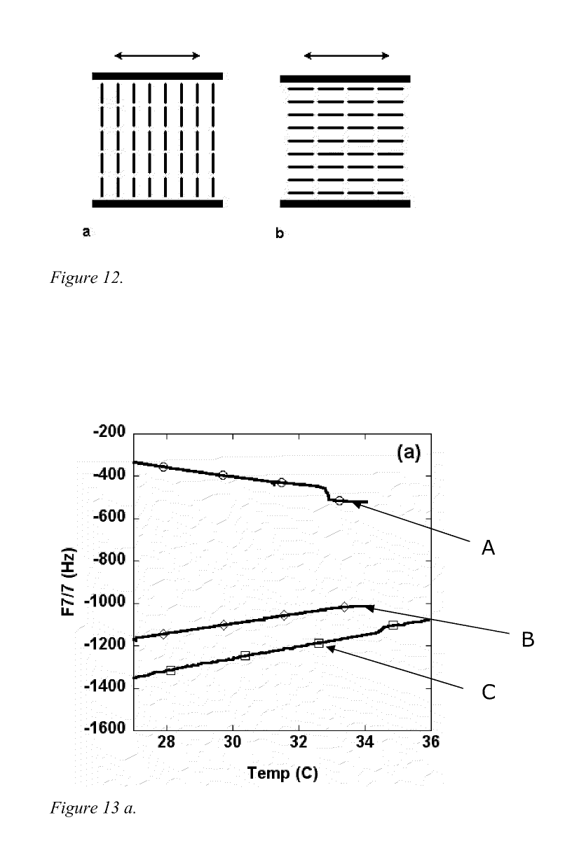

Circular standard microscope cover slides with a diameter of 9 mm and thicknesses of 170 μm to 2000 μm were used as lids. A thin (100 nm) layer of SiO₂ was evaporated on these. The spacers are fabricated by masking the areas, which after the fabrication step form the confined space containing the soft matter or fluid, and evaporating of metal to form circular walls. The geometry of the walls was circular, having a width of about 0.5 mm following the edge of the lids and included two channels for loading and unloading of sample material. Spacers with thicknesses of 30 nm to 280 nm were used. The viscous properties for thin, confined films of the liquid crystal 5CB (4-n-pentyl-4′cyanobiphenyl) where then studied with the novel device. For this purpose, as the bottom piece, a QCM-D sensor, which is a planar, circular quartz crystal with a 50 nm thick evaporated gold electrode on each side, was used. The gold electrode on the top of the quartz crystal had a diameter of 10 mm (slightly larger than the diameter of the lids) and had the function to act as sensor for changes in the viscoelastic properties (by measuring the dissipation factor D) as well as to act as the bottom of the cell. The electrode surface as well as the lid was modified with a thin layer of SiO₂ evaporated on top to induce planar orientation of the liquid crystal film at a predetermined direction. Potentially the surfaces could be treated in a vast number of ways, for example, in order to induce homeotropic orientation (FIG. 12 a), coated with the polymer NISSAN-1211.

A very small volume of 5CB was deposited on the bottom piece with a very fine pipette followed by putting the lid with the spacers on top, forming a sandwich-like structure. In order to get rid of the excess liquid, the cell was heated sufficiently to evaporate the latter until the lid with the spacers had “landed” on the bottom piece. Once this occurred the pieces were held together by capillary forces, making the sample stable. In this way, cells with confined liquid crystal of several different thicknesses were made. The dissipation factors for the different samples were measured while increasing temperature at a rate of 0.3 K/min, above the nematic-isotropic phase transition temperature.

Theoretically it has been predicted that the viscoelastic properties of a confined liquid crystal in the nematic phase, depends on the molecular orientation in relation to the shear direction, and the thickness of the film. We show here experimentally, by using the novel nanocell as experimental device, that the dissipation properties of samples oriented parallel to the shear and perpendicular to the shear exhibit different characteristic in the nematic phase but coincide in the isotropic phase as the determined orientation is lost.

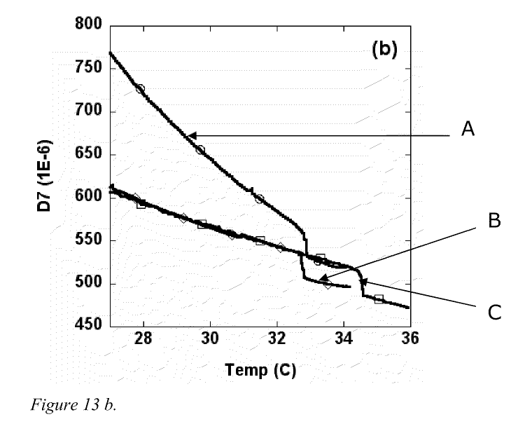

In FIG. 13 the resonant frequency and dissipation factor measured at the seventh overtone frequency is shown for the thicknesses 30 nm, 280 nm and 600 μm, as a function of temperature for different samples oriented perpendicular to the shear direction of the QCM-D sensor. The transition to the isotropic phase is clearly visible at around 33° C. In the three cases the characteristics of the curves depend reproducibly on the film thickness.

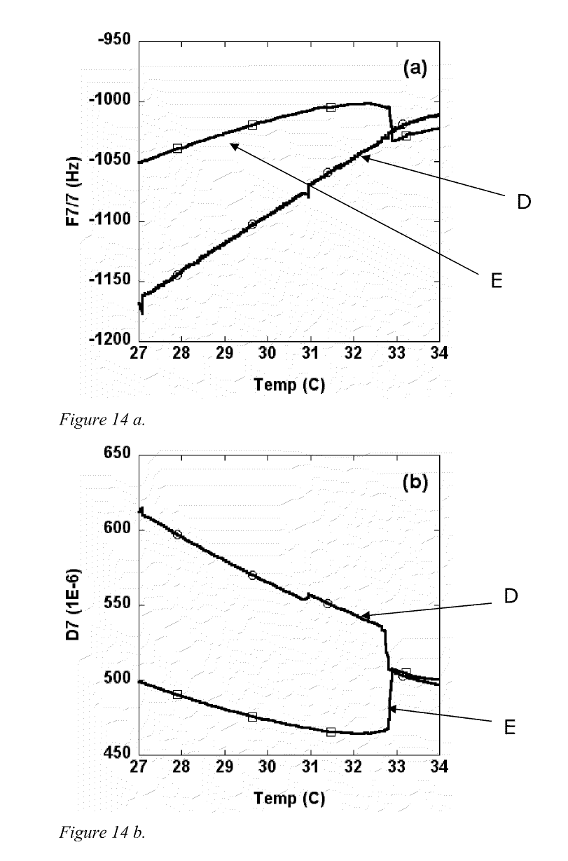

In FIG. 14 the spacers are 280 nm thick and made of gold to form circular walls. The graphs show the data of the frequency and dissipation shifts at the seventh overtone (F5) of 5CB oriented perpendicular to the shear of the sensor and parallel to the shear, respectively. This method gives excellent control of the radial confinement of the sample and hence very good reproducibility in terms of temperature dependence and step height at the phase transition.

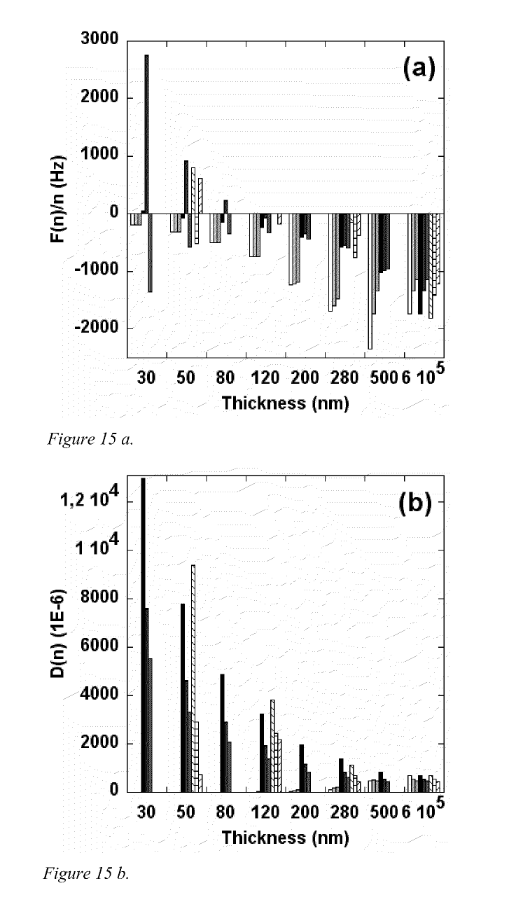

FIG. 15 shows the dissipation shift at the seventh overtone (D7) for nanocell samples of the isotropic liquid ethylene glycol. Several different samples with a confined film thickness ranging from 30 nm to 500 nm are shown together with the result obtained from a bulk sample with thickness 600 μm. Calculated values for 30, 50, 80, 120, 200, 280, 500 nm and 600 μm and experimental values for 50, 120, 280 nm and 600 μl m are presented. The walls are fabricated by the masking and evaporation method, giving circular, entirely enclosed volumes of liquid. This gives good reproducibility and an obvious difference between the different thicknesses. The higher dissipation factor for the thinner films indicates that a larger fraction of the liquid is influenced by interfacial interactions, giving a stronger sensor-lid coupling.

As an example of a nanocell operating in flow mode, referring to FIG. 11, a glass or Plexiglas slide is used as a lid 19 with two holes, one for inlet 21 and one for outlet 22 of matter. A spacer 18 is made by photolithography in PDMS and bonded onto the glass lid by ionizing of the contacting surfaces by plasma treatment. A QCM-D 17 sensor is then placed on the spacer ring according to FIGS. 10 and 11, which in its turn is held in place by electrodes 24 connected to the electronics 23. Very fine pipes are connected to the inlet and outlet holes. The sample fluid is then pumped through the cell with a pump device. It is obvious from theory that decreased volume clearly improves the (diffusion limited) kinetics of surface induced reaction processes. Also, using a smaller cell demands much less sample material compared to larger ones.

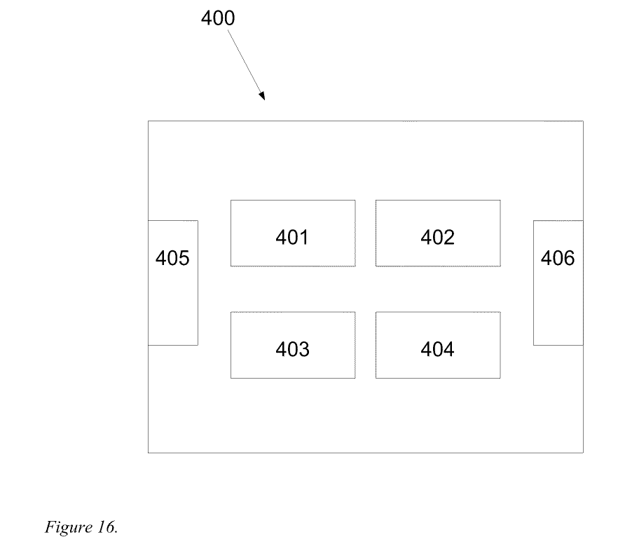

FIG. 16 illustrates a control and measurement device for controlling and taking readings from measurements in systems where the nanocell according to the present invention is part of The control and measurement device 400 comprise at least one computational unit 401, a volatile memory unit 402 (e.g. RAM, DRAM, and so on) and/or a non-volatile memory 403 (e.g. ROM, EEPROM, Flash, hard disk, and so on) and an interface unit 404 for interfacing with a user. The device 400 may also comprise a communication unit and interface 405 for communicating with a network (e.g. Ethernet using any suitable type of network protocol, for instance wireless or wired protocols such as, but not limited to, 802.11, 802.15, 802.16, TCP/IP, UDP, ATM or similar protocols) and a measurement interface 406 for interfacing to the measurement system (the measurement interface may be using Ethernet, GPIB, HPIB, RS232, RS485, Firewire or similar interface standards for communicating with external measurement devices or external measurement interfaces or it may be using a direct measurement signal link using ADC and/or DAC (analog to/from digital converters) and/or digital I/O interfaces for controlling measurement details). Software is provided for controlling and taking readings from the measurement system. The nanocell may comprise interface connectors for connecting to the control and measurement electronics.

With the invention presented we have been able to show that it is possible to confine very thin films of soft matter, down to the nanometer regime, using two parallel plates and spacers, and obtain reproducible data. The nanocell has been used integrated with a sensor, inducing shear, making it possible to obtain information about the viscous properties of the confined soft matter. It is, first, shown that a calimatic liquid crystal with molecules oriented perpendicular relative to the shear is, in terms of viscoelastic properties, different from the case when it is oriented parallel to the shear in the nematic phase but equivalent in the isotropic phase.

The most interesting result, however, is that the thinner the confined film is, both in the case of liquid crystals as well as in the case of ethylene glycol, the larger is the influence from the interfacial regions become. This is clear from the presented graphs, which show a clear change in dissipation factor and resonant frequency change for thin films of ethylene glycol and for liquid crystals, as a function of confined film thickness.

Also, we have stated that it is possible to use the invention as a miniaturized reaction chamber in order to perform and, by sensing, monitor biotechnical, chemical and physical processes and reactions. This may be done with much better performance and less sample consumption compared to the technology of today.

It should be noted that even though the invention has been described with two parallel plates forming lid and bottom respectively the device may be formed using non-parallel plates.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, and that several “means”, “devices”, and “units” may be represented by the same item of hardware.

FIG. 1 shows examples of how a nanocell may look like according to the present invention. It may for example have enclosing walls 1 or point wise pillars 2, separating a lid 3 and a bottom 6. Even though the above example is shown as a circular structure as seen from a top and side view, the device may have other geometrical shapes, such as rectangular, triangular, or it can be of a more irregular shape.

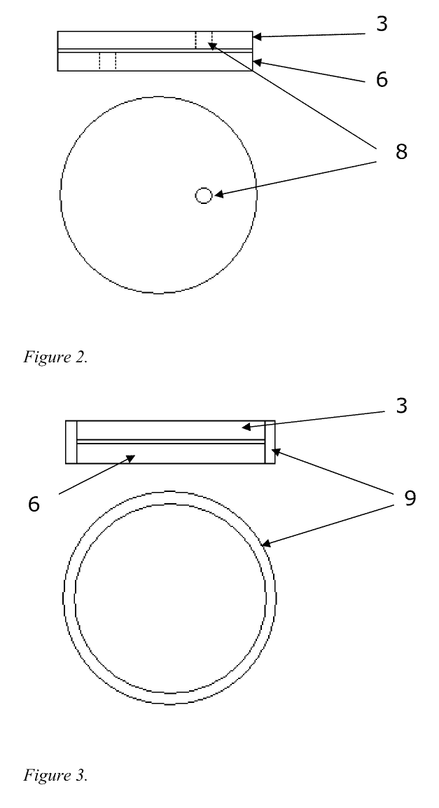

FIG. 2 illustrates the principle with holes 8 in the bottom 6 and the top 3 plate for e.g. liquid or gas access.

FIG. 3 shows a nanocell with walls 9 outside the lid and the bottom plate.

FIG. 4 shows a nanocell with spacers 10 attached onto external structures.

FIG. 5 exemplifies that the spacers 11 can have several heights in one single cell, defining several levels of thickness.

FIG. 6 shows a cell comprising several chambers 12, connected by channels and/or valves.

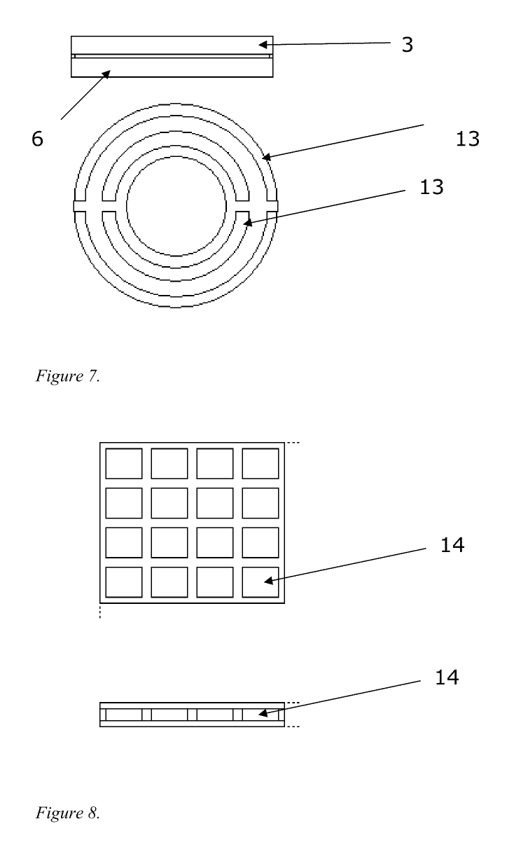

FIG. 7 shows a cell with multiple walls 13.

FIG. 8 illustrates how several cells 14 forming an array or a matrix. The individual cells may be connected by channels and/or valves or be isolated from each other.

FIG. 9 shows an example of nanostructures, comprising spacers 15 and channels 16, stacked on each other, forming a multilayer structure that can be used e.g. for filtering purposes.

FIG. 10 is a concrete example on a nanocell combined with a QCM-D sensor 17, separated by a spacer structure 18 from a lid 19, defining a space of a few micrometers height 20, combined with inlet-21 and outlet 22 channels.

FIG. 11 shows the same structure as FIG. 10, but with driving electronics 23 connected to the QCM-D sensor 17 by electrodes 24.

FIG. 12 shows (a) Liquid crystal film confined between two parallel plates oriented homeo-tropically. The bars illustrate the molecules and the arrow the shear direction. (b) Liquid crystal film oriented parallel to the shear direction.

FIG. 13 illustrates the change in resonant frequency (a) and dissipation factor (b) at the seventh overtone (F7) for two different 30 nm (A) and 280 nm (B) thick confined 5CB films, and a 600 μm bulk film (C), as a function of temperature.

FIG. 14 shows the raw values resonant frequency (a) in dissipation (b) change for 280 nm thick samples of 5CB with two different orientations confined in a nanocell: lid and bottom perpendicular to the shear (D) and lid and bottom parallel to the shear (E).

FIG. 15 is a comparison of the shift in resonant frequency (a) and dissipation factor (b) of ethylene glycol in three different conditions calculated using the viscoelastic Voight-Voinova layer model, with respect to film thickness for the third (left bar), fifth (middle bar) and seventh (right bar) overtones: A free film (light bars), a film confined between the substrate and a thick lid (2.5 mm thick) (dark bars). The striped bars represent the corresponding experimental values, using the thick lid, for a few film thicknesses (50, 120, 280 nm, using nanocells, and 600 μm, using a commercially available chamber). In the representation the resonant frequency (a) and dissipation factor (b) minus the corresponding values for an unloaded sensor are plotted. As expected, the bulk values overlap for all conditions, and also the trend predicted theoretically for the thick lid confined case holds experimentally. The walls are circular and entirely enclosing the film and the inner surfaces are SiO₂ for all cases.

FIG. 16 illustrates a control and measurement device for controlling and taking readings from measurements in systems where the nanocell according to the present invention is part of.

The above mentioned and described embodiments are only given as examples and should not be limiting to the present invention. Other solutions, uses, objectives, and functions within the scope of the invention as claimed in the below described patent claims should be apparent for the person skilled in the art.

1. A nanocell for holding a small volume of soft matter or fluid, said nanocell comprising:
a first structure (3) with a substantially flat surface in one direction;
a second structure (6) with a substantially flat surface in one direction; and
at least one spacer (1, 2);
wherein said substantially flat surface of each first and second structure face each other and are separated by the at least one spacer and the two surfaces and the spacer together define a volume (7) between them for holding said soft matter or fluid, and the distance defined by the spacer between said surfaces of the first and second structure is less than 1 micrometer; the volume between the surfaces of the first and second structures and the spacer is in the range between 1 femto liters and 1 micro liters.

2. The nanocell according to claim 1, wherein at least one width substantially parallel to at least one of the substantially flat surfaces of the first and second structure is of the millimeter order.

3. The nanocell according to claim 1, wherein said surfaces of the first and second structure are substantially parallel to each other.

4. The nanocell according to claim 1, wherein at least the inner surfaces of the nanocell has been customized for at least one of optimizing physical and chemical properties depending on measurement.

5. The nanocell according to claim 4, wherein the customization comprise at least one of geometrical structure, coating, surface structure, and chemical reactivity (e.g. hydrophilic or hydrophobic properties).

6. The nanocell according to claim 1, further comprising at least one of at least one sensor (17), at least one membrane, at least one flow inlet (21), at least one outlet (22), and at least one flow steering device.

7. The nanocell according to claim 1, wherein the spacer is formed integrally of one of the first or second structure.

8. The nanocell according to claim 1, wherein the spacer comprises a nano sized object.

9. The nanocell according to claim 8, wherein the nano sized object is at least one of a nanotube, nanowire, and nano sphere.

10. The nanocell according to claim 1, wherein the spacer is made of at least one of a piezoelectric material and a magnetoelastic material.

11. The nanocell according to claim 1, wherein the spacer is made of a plurality of layers.

12. The nanocell according to claim 1, wherein at least one of the first, the second structure, and the spacer comprise an opening (8, 21, 22) connecting the defined volume (7) with an external volume.

13. The nanocell according to claim 1, wherein at least one of said surfaces is convex or concave.

14. A measurement device for measuring physical or chemical properties of soft matter, said device comprising at least one nanocell according to claim 1 with interface connectors for control and measurement electronics, the measurement device further comprising signal processing means and communication interface.

15. A method of manufacturing a nano cell, comprising the steps of:
providing a first structure with a substantially flat surface;
providing at least one spacer structure positioned on the substantially flat surface of the first structure;
providing a second structure with a substantially flat surface on the spacer;
assembling the second structure in relation to the first structure and the at least one spacer;
wherein the spacer structure is less than 1 micrometer in a direction between the surfaces of the first and second structure and the volume defined by the two surfaces and the spacer structure is in the range of 1 femto liters to 1 micro liters.

16. The method according to claim 15, wherein the step of providing at least one spacer comprises a step of using at least one of photolithography, electron beam lithography; evaporation techniques, sputtering, masking, colloidal lithography, spin coating, epitaxial growth and mechanical depositing of particles.

17. The method according to claim 15, wherein the step of assembling comprises using at least one of anodic bonding, polymer cross linking, gluing, fusion bonding, magnetic forces, electrostatic forces, and capillary forces.
